(19) United States
(12) Patent Application Publication
(10) Pub. No.: US 2017/0192526 A1
(43) Pub. Date: Jul. 6, 2017

(54) Input Service Providing Multiple Input Processors

(71) Applicant: Microsoft Technology Licensing, LLC, Redmond, WA (US)

(72) Inventors: Harley Rosnow, Kirkland, WA (US); Daniel Chang, Redmond, WA (US)

(21) Appl. No.: 14/985,966

(22) Filed: Dec. 31, 2015

(51) Int. Cl. G06F 3/023; G06F 3/01; G06F 3/0488; G06F 17/27; G06F 3/0489; G06F 3/0484; G06F 3/02; G06F 3/16; G06F 17/24

(52) U.S. Cl. CPC G06F 3/023; G06F 3/167; G06F 3/017; G06F 3/04883; G06F 17/24; G06F 3/0489; G06F 3/04842; G06F 3/0227; G06F 17/275

(57) ABSTRACT

An input service manages multiple edit buffers and multiple input processors for processing user input. The input service is available to any number of applications. The input service manages the edit buffers and the input processors such that at any given time, only one edit buffer is active and only one input processor is active. The multiple input processors can include one keyboard input processor and any number of non-keyboard input processors.

### BACKGROUND

In the early days of personal computers, users would typically purchase shrink-wrapped software applications, which were loaded onto a personal computer from a floppy disk or CD. Applications were produced by a limited number of companies, and security was not a significant concern. However, in more recent years, software applications have become available from an ever-growing number of sources. For example, online app stores have become prevalent, allowing a user to download any number of applications directly to a personal computer, mobile phone, or any other type of computing device. Furthermore, security has become a greater concern.

To address some of the security risks posed by easy access to software created by more unknown developers, many operating systems were modified to limit an application's access to various parts of the computing system. For example, operating systems may include a security boundary within which an application is installed and executed. As such, the application may be prevented from reading from or writing to specific locations on the hard drive, reading from or writing to the registry, determining a current geographical location, accessing a network, and so on.

An input processor receives and processes user input, which may be received from, for example, a keyboard, a microphone, a touch screen, and so on. Because applications execute within the above-described security boundary, each application that allows user input includes its own input processor to receive and process user input. For example, a word processing application typically includes an input processor to handle input from a keyboard. The input processor may also be configured to handle, for example speech input through a microphone and/or handwriting input through a touch screen and a stylus. In existing architectures, each application includes an input processor to handle the various types of input that the application is configured to receive. The security constraints that have been implemented to restrict application access to sensitive portions of the system have also had a negative impact on the implementations of input processors. For example, if an input processor cannot access a hard drive or other storage device, the input processor is unable to remember a particular user's input style, frequently used words (e.g., children's names), and so on. Furthermore, if the input processor does not have access to a network, the input processor cannot share such information with other devices.

With the advent of mobile computing devices such as mobile phones, a new architecture was developed for mobile devices, which separates the input processor from the applications. In this architecture, the operating system includes an input service, which includes an input processor and an edit buffer. If an application supports document creation, for example, the application can edit the document directly, but user input to the document is handled by the input processor in the input service. The input service includes an edit buffer, which includes a copy of relevant portions of the document. A protocol is implemented to maintain synchronization between the document and the edit buffer. The input service includes a single input processor, which is configured to handle any of various types of input such as, for example, keyboard input, speech input, or handwriting input.

### SUMMARY

An input service is implemented as part of an operating system to provide multiple input processors that may be utilized by any number of applications to process user-submitted input. The input service manages a plurality of edit buffers and a plurality of input processors, including one keyboard input processor and any number of non-keyboard input processors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The same numbers are used throughout the drawings to reference like features and components.

FIG. 1 is a block diagram illustrating an example environment in which an input service providing multiple input processors can be implemented.

FIG. 2 is a block diagram illustrating select components of an example input service as described herein.

FIG. 3 is a state transition diagram for an edit buffer managed by an example input service as described herein.

FIG. 4 is a state transition diagram for a keyboard input processor managed by an example input service as described herein.

FIG. 5 is a state transition diagram for a non-keyboard input processor managed by an example input service as described herein.

FIG. 6 is a pictorial diagram that illustrates example state changes to edit buffers and input processors based on user interaction with an example email application.

FIG. 7 is a flow diagram of an example method of managing multiple edit buffers and multiple input processors when an edit control is selected.

FIG. 8 is a flow diagram of an example method of managing multiple edit buffers and multiple input processors based on how an edit control is selected.

FIG. 9 is a flow diagram of an example method of managing multiple input processors when a non-keyboard input processor is selected.

FIG. 10 is a flow diagram of an example method of processing user input with an input service as described herein.

FIG. 11 is a flow diagram of an example method of managing multiple input processors when a new user input language is selected.

### DETAILED DESCRIPTION

Introduction

The following discussion is directed to an input service that is accessible to multiple applications and provides multiple edit buffers and multiple input processors. As described herein, an input service manages multiple edit buffers, which may be associated with multiple respective applications. The input service also manages multiple input processors, each of which is configured to handle a particular type of user input and can be accessed by the multiple applications.

A single input service that provides multiple input processors accessible to multiple applications reduces the complexity of application development by removing the need for each application to include an input processor. The input service provides flexibility to easily add additional input processors to support different types of input. Furthermore, the input service described herein results in input processing consistency across multiple applications, which does not exist in architectures in which each application includes one or more proprietary input processors.

Example Environment

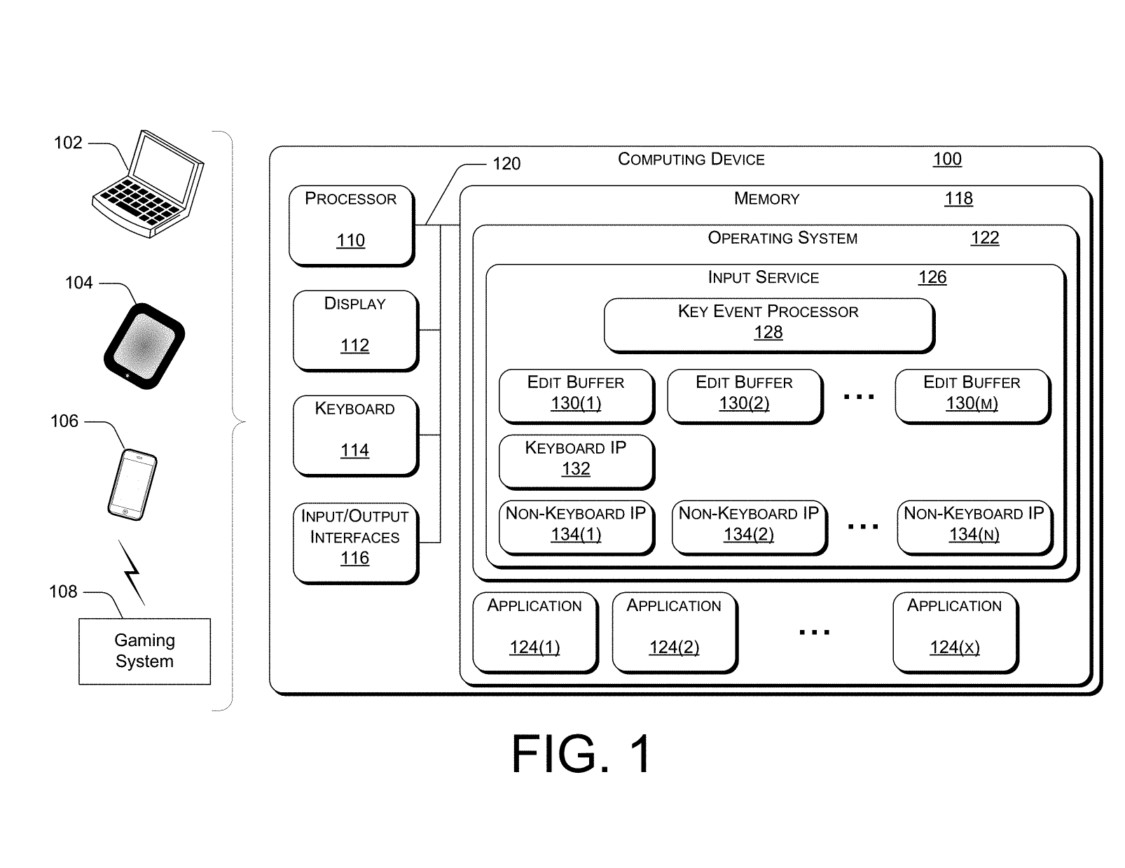

FIG. 1 illustrates select components of an example computing device 100 in which an input service as described herein can be implemented. Example computing device 100 may represent any type of computing device that can receive user input, including, but not limited to, a desktop or laptop personal computer 102, a tablet computer 104, a smartphone, or a gaming system 108. Example computing device 100 includes a processor 110, a display 112, a keyboard 114, input/output interfaces 116, and a memory 118.

Display 112 may be a component of computing device 100, such as a display on a laptop computer 102, tablet computer 104, or smartphone 106, or may be a separate display device connected to the computing device 100, as with a desktop computing device, or gaming system connected to a monitor or television display. Similarly, keyboard 114 may be a component of computing device 100, such as a laptop computer keyboard or a keyboard presented on a touch screen of a tablet computer or smartphone. Alternatively, keyboard 114 may be a separate keyboard that this communicatively coupled to the computing device, as with a desktop computing device. A gaming system may present an on-screen keyboard with which a user interacts through a game controller.

Input/output interfaces 116 enable computing device 100 to present or receive data via one or more input/output devices. For example, input/output interfaces 116 may enable computing device 100 to receive speech input via a microphone (not shown) or gesture input via a camera (not shown). Processor 110, display 112, keyboard 114, input/output interfaces 116, and memory 118 are connected via a bus 120, which in some instances can include one or more of a system bus, a data bus, an address bus, a PCI bus, a Mini-PCI bus, and any variety of local, peripheral, and/or independent buses.

Memory 118 stores operating system 122 and one or more applications 124, such as application 124(1), 124(2), . . . , 124(x). Application 124 represent any of a variety of applications including, but not limited to, a word processing application, a spreadsheet application, a presentation application, an email application, an Internet browser application, and so on. Operating system 122 includes input service 126, which includes key event processor 128, one or more edit buffers 130, a keyboard input processor 132, and one or more non-keyboard input processors 134.

In an example implementation, key event processor 128 controls instantiation, activation, deactivation, and destruction of edit buffers 130, keyboard input processor 132, and non-keyboard input processors 134. In the described example, input service 126 may include instantiations of any number of edit buffers, although only one edit buffer is allowed to be active at a given time. For example, a word processing application 124(1) may cause input service 126 to instantiate an edit buffer 130(1) for storing clipboard contents to support copy and paste operations. While the word processing application 124(1) is running, an email application 124(2) may also be running The email application 124(2) may cause input service 126 to instantiate edit buffers 130(2)-130(5), corresponding, for example, to a “to” edit control, a “cc” edit control, a “subject” edit control, and an “email body” edit control, respectively. At any given time, the active edit buffer is the edit buffer that corresponds to a most recently selected edit control (e.g., a text box on a user interface that currently has focus).

Input service 126 allows, at any one time, only one instantiation of a keyboard input processor 132, although, input service 126 may support multiple languages. For example, input service 126 may instantiate an English language keyboard input processor 132. Later, the user's input language may be changed to Japanese. In this scenario, input service 126 destroys the instantiation of the English language keyboard input processor 132 and instantiates a Japanese language keyboard input processor 132.

Input service 126 allows instantiations of multiple non-keyboard input processors 134. Examples of non-keyboard input processors can include, but are not limited to, a speech input processor, a handwriting input processor, a gesture input processor, a sign language input processor, a lip reading input processor, a translation input processor, a transliteration input processor, a Unicode input processor, an emoticon input processor, a mathematics input processor, and an auxiliary device input processor.

As an example, as shown in FIG. 1, smailphone 106 may communicate with gaming system 108, for example, via a Bluetooth or other type of communication connection. In an example, smailphone 106 may include an application that allows a user to provide user input for the gaming system 108 via the application on the smailphone 106. In this example, an auxiliary device input processor may receive and process the user input that is directed to the gaming system 108, but received via the smailphone 106.

Operating system 122 and applications 124 are examples of executable instructions stored on memory 118, which are loadable and executable by processor 110. Alternatively, or in addition, the functionally described herein can be performed, at least in part, by one or more hardware logic components such as accelerators. For example, and without limitation, illustrative types of hardware logic components that can be used include Field-programmable Gate Arrays (FPGAs), Application-specific Integrated Circuits (ASICs), Application-specific Standard Products (AS SPs), System-on-a-chip systems (SOCs), Complex Programmable Logic Devices (CPLDs), etc. For example, an accelerator can represent a hybrid device, such as one from ZYLEX or ALTERA that includes a CPU embedded in an FPGA fabric.

Memory 118 is a form of computer-readable media, and can store instructions executable by the processor 110. Computer-readable media can also store instructions executable by external processing units such as by an external CPU, an external GPU, and/or executable by an external accelerator, such as an FPGA type accelerator, a DSP type accelerator, or any other internal or external accelerator. In various examples at least one CPU, GPU, and/or accelerator is incorporated in computing device 100, while in some examples one or more of a CPU, GPU, and/or accelerator is external to computing device 100.

Computer-readable media may include computer storage media and/or communication media. Computer storage media can include volatile memory, nonvolatile memory, and/or other persistent and/or auxiliary computer storage media, removable and non-removable computer storage media implemented in any method or technology for storage of information such as computer-readable instructions, data structures, program modules, or other data. Memory 118 can be an example of computer storage media. Thus, the memory 118 includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

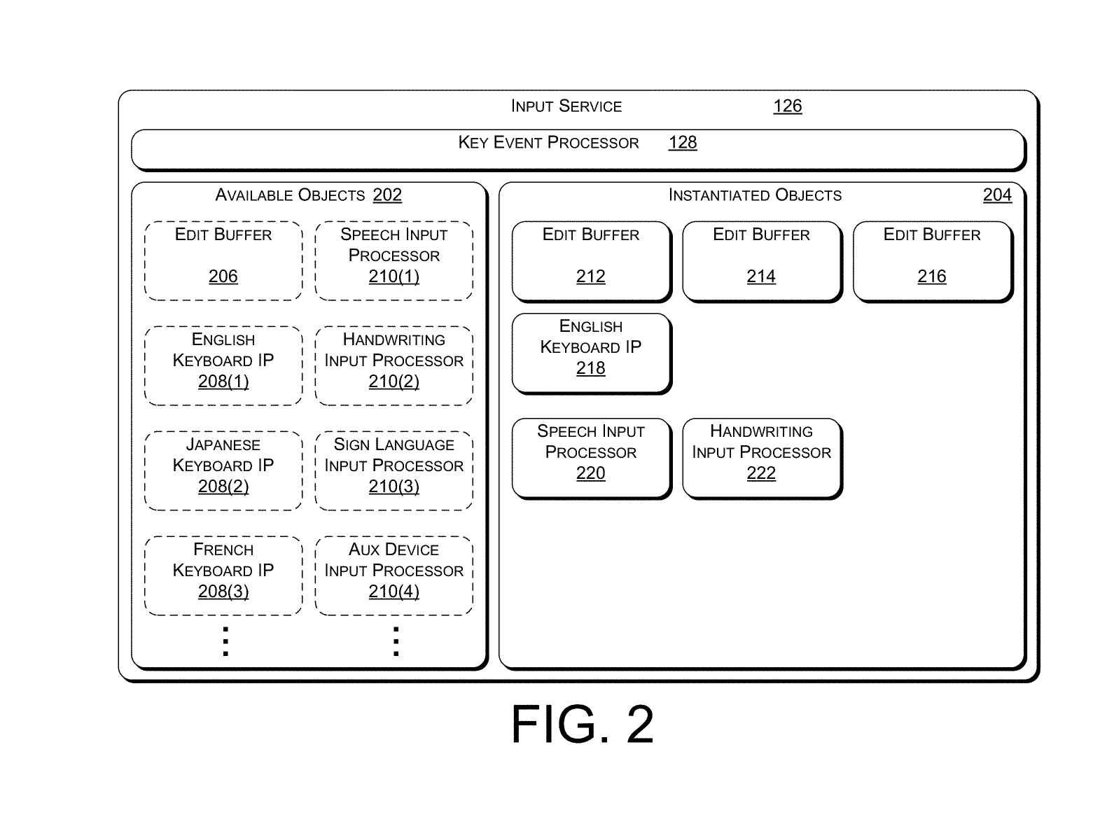

FIG. 2 illustrates select components of an input service 126 as described herein. As described above with reference to FIG. 1, input service 126 includes key event processor 128, any number of instantiated edit buffers 130, a single instantiated keyboard input processor 132, and any number of instantiated non-keyboard input processors 134.

As illustrated in FIG. 2, input service 126 may include a number of available objects 202 from which instantiated objects 204 may be created. For example, available objects 202 may include an edit buffer object 206, any number of keyboard input processor objects 208, and any number of non-keyboard input processor objects 210. For example, available objects 202 may include an English keyboard input processor 208(1), a Japanese keyboard input processor 208(2), a French keyboard input processor 208(A), and any number of keyboard input processors to support other languages.

Similarly, available objects 202 may also include any number of non-keyboard input processors, such as, but not limited to, speech input processor 210(1), handwriting input processor 210(2), sign language input processor 210(3), and auxiliary device input processor 210(4). In an example implementation, new objects can be developed and registered with the computing device 100 at any time. New input processor objects may include, for example, a new keyboard input processor object to support a previously unsupported language or a new non-keyboard input processor to support a previously unsupported input modality. When a new input processor object is registered with the computing device 100, the new object is added to available objects 202, and is then available for instantiation as a new input processor.

The key event processor 128 instantiates objects based on available objects 202. For example, while a user is interacting with one or more applications, key event processor 128 may use available edit buffer object 206 to instantiate edit buffer 212, edit buffer 214, and edit buffer 216, each corresponding to a different edit control. Similarly, key event processor 128 may instantiate English keyboard input processor 218 based on the English keyboard input processor 208(1) available object. Furthermore, key event processor 128 may use available object speech input processor 210(1) to instantiate speech input processor 220, and key event processor 128 may use available object handwriting input processor 210(2) to instantiate handwriting input processor 222.

Example State Transitions

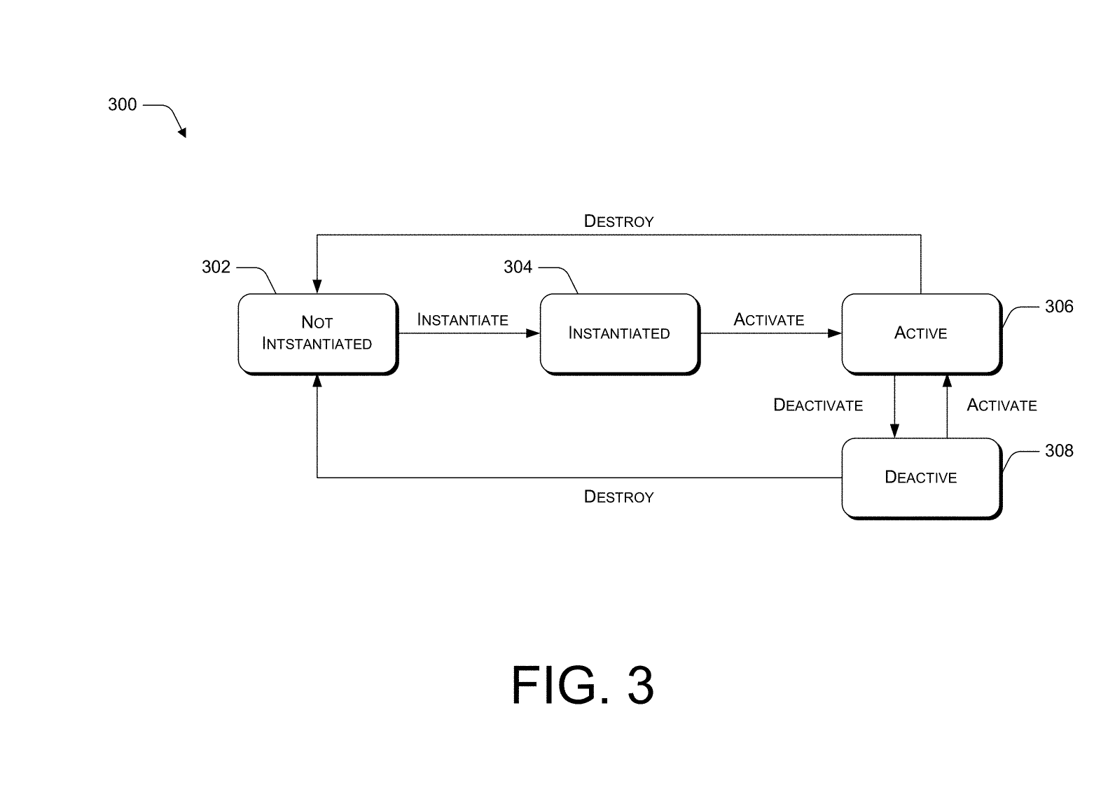

FIG. 3 illustrates example state transitions 300 of an edit buffer object, such as edit buffers 130 shown in FIG. 1 and edit buffers 212, 214, and 216 shown in FIG. 2. As described above with reference to FIG. 2, an edit buffer can be instantiated based on an available edit buffer object 206. Available edit buffer object 206 is not instantiated, and corresponds to the not instantiated state 302. When the key event processor creates an edit buffer object (e.g., edit buffer 212 shown in FIG. 2), the newly created edit buffer object is instantiated and activated, moving to the instantiated state 304 and then to the active state 306. An instantiated edit buffer object may move between the active state 306 and a deactive state 308. For example, if the edit buffer is associated with a “to:” edit control in an email application, and the user selects the “cc:” edit control, the edit buffer associated with the “to:” edit control moves to the deactive state 308, and an edit buffer associated with the “cc:” edit control moves to an active state 306.

In an example implementation, while an application is running, any edit buffers instantiated in association with the application will remain in either the active state 306 or the deactive state 308. When the application stops running (e.g., the user closes the application), any edit buffers associated with the application are destroyed. That is, the instantiated edit buffers associated with the application are destroyed, essentially moving each of those edit buffers to a not instantiated state 302.

As described above, any number of edit buffer objects may be instantiated at a given time. However, only one edit buffer object may be in the active state 306 at a given time, while the other instantiated edit buffer objects will be in the deactive state 308.

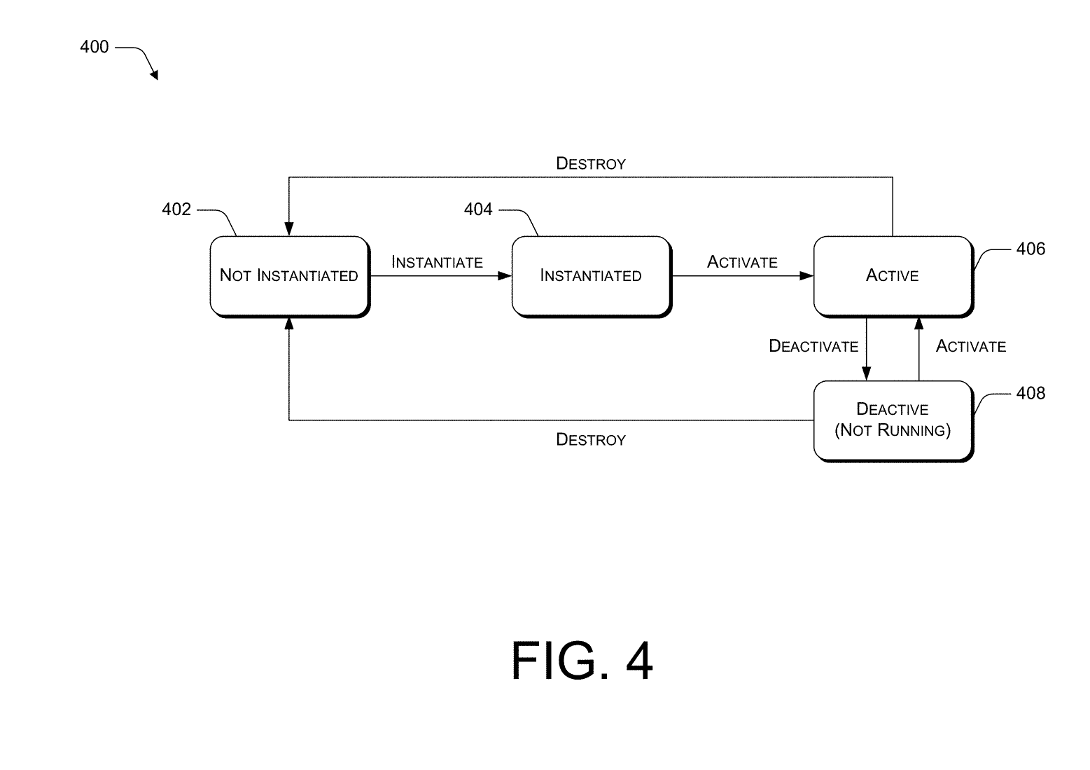

FIG. 4 illustrates example state transitions 400 of a keyboard input processor object, such as keyboard input processor 132 shown in FIG. 1 and English keyboard input processor 218 shown in FIG. 2. As described above with reference to FIG. 2, a keyboard input processor can be instantiated based on an available keyboard input processor object 208. Each available keyboard input processor object 208(1), 208(2), 208(3), . . . is not instantiated, and corresponds to the not instantiated state 402. When the key event processor creates keyboard input processor object (e.g., English keyboard input processor 218 shown in FIG. 2), the newly created keyboard input processor object is instantiated and activated, moving to the instantiated state 404 and then to the active state 406. An instantiated keyboard input processor object may move between the active state 406 and a deactive state 408. For example, if a user is typing text into an edit control in an application, the keyboard input processor object is in the active state 406. However, if the user makes a menu selection or otherwise requests to use a microphone to dictate input to the edit control, the keyboard input processor object will move to the deactive state 408.

When a keyboard input processor object is in the deactive state 408, the keyboard input processor is not running That is, in addition to not processing user input, the deactive keyboard input processor object also does not receive event notifications from the key event processor 128. The key event processor 128 may activate the keyboard input processor to move the keyboard input processor object from the deactive state 408 to the active state 406, for example, if the user selects a new edit control for user input.

In an example implementation, key event processor 128 will destroy the instantiated keyboard input processor object if a new keyboard input processor object is requested. For example, if the user selects a new user input language, the instantiated keyboard input processor object associated with the previously selected user input language will be destroyed, to make room for a new instantiation of a keyboard input processor object associated with the newly selected user input language.

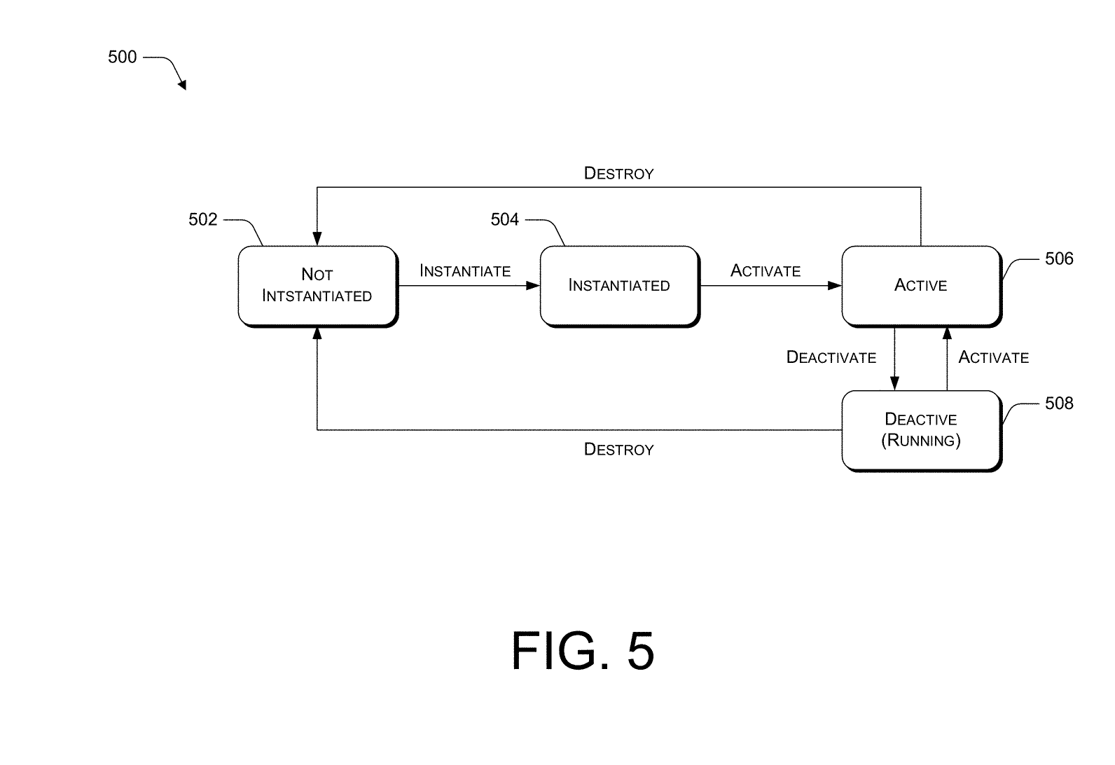

FIG. 5 illustrates example state transitions 500 of a non-keyboard input processor object, such as non-keyboard input processors 134 shown in FIG. 1 and speech input processor 220 and handwriting input processor 222 shown in FIG. 2. As described above with reference to FIG. 2, a non-keyboard input processor can be instantiated based on an available non-keyboard input processor object 210. Each available non-keyboard input processor object 210(1), 210(2), 210(3), 210(4), . . . is not instantiated, and corresponds to the not instantiated state 502. When the key event processor creates a non-keyboard input processor object (e.g., speech input processor 220 shown in FIG. 2), the newly created non-keyboard input processor object is instantiated and activated, moving to the instantiated state 504 and then to the active state 506. An instantiated non-keyboard input processor object may move between the active state 506 and a deactive state 508. For example, if a user makes a menu selection or otherwise requests to use a microphone to dictate input to an edit control, the speech input processor will move to the active state 506. If the user then selects another edit control, the keyboard input processor object (discussed above with reference to FIG. 4) will move to an active state 406, and the speech input processor will move to the deactive state 508.

In contrast to the keyboard input processor objects described above with reference to FIG. 4, when a non-keyboard input processor object is in the deactive state 508, the non-keyboard input processor is still running That is, although the non-keyboard input processor is not processing user input, the deactive non-keyboard input processor may receive event notifications from the key event processor 128. For example, if an active non-keyboard input processor declines to processes received user input, other running, but deactive non-keyboard input processors may receive notification of the input, and be given the opportunity to request to process the input.

In an example implementation, key event processor 128 will destroy an instantiated non-keyboard input processor object when requested by the non-keyboard input processor or when the system terminates.

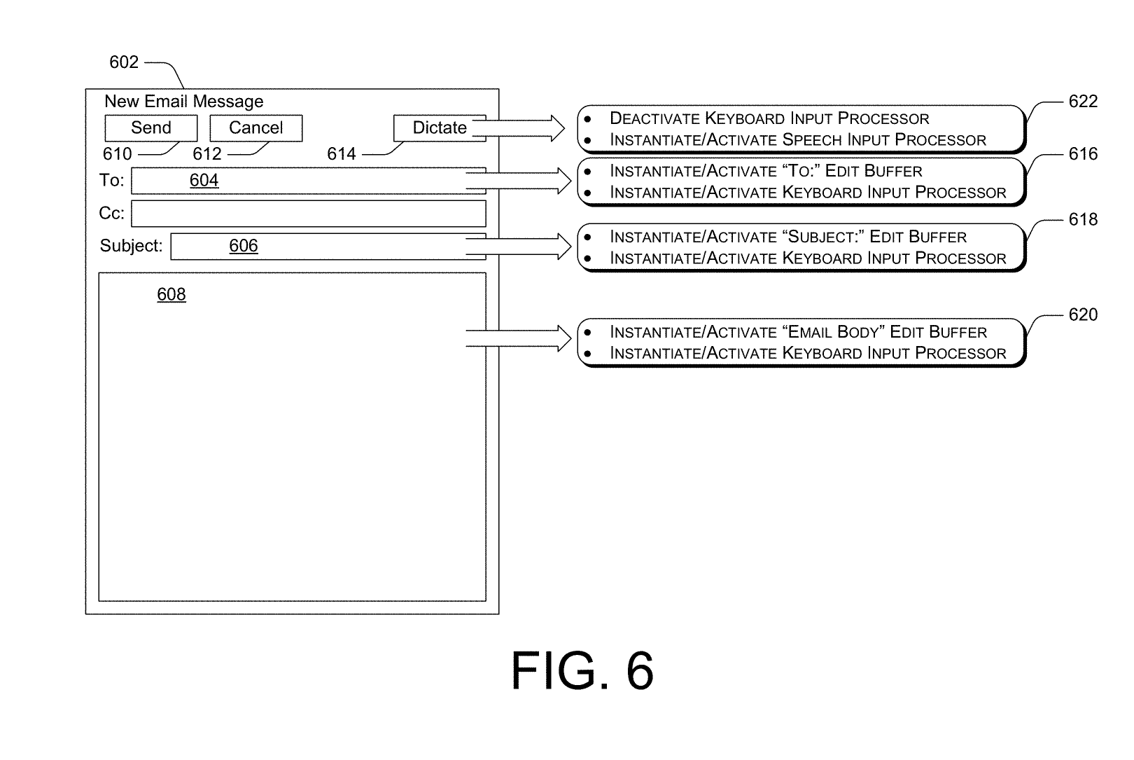

FIG. 6 illustrates example state changes to edit buffers and input processors based on user interaction with an example email application. In an example implementation, when a user interacts with an email application to create a new email message, the application causes display of a new email message user interface 602. In the illustrated example, the new email message user interface 602 includes a “to” edit control 604, a “subject” edit control 606, a “body” edit control 608, a send button 610, a cancel button 612, and a dictate button 614.

In an example implementation, when the new email message user interface 602 is presented, the cursor is in the “to” edit control 604, which has the focus. As described herein, an edit control is said to “have the focus” when the edit control has been selected such that user input (e.g., via a keyboard or other input means) is targeted to the edit control. Accordingly, key event processor 128 creates an edit buffer to correspond to the “to” edit control 604 and activates the edit buffer. Furthermore, as indicated by box 616, a keyboard input processor is activated. If a keyboard input processor was already instantiated and active, then no change occurs. If the keyboard input processor is instantiated, but deactive, then key event processor 128 deactivates whichever input processor is active, and activates the keyboard input processor. If no keyboard input processor is instantiated, then key event processor 128 instantiates and activates a keyboard input processor based on the default or previously specified user's input language.

When a user selects (e.g., via a mouse click or a tab key press) the “subject” edit control 606, or the “body” edit control 608, key input processor creates and/or activates an edit buffer corresponding to the selected edit control and ensures that the keyboard input processor is active, as indicated by boxes 618 and 620, respectively.

If at any time, a user selects the dictate button 614, indicating that the user will be dictating input through a microphone, the key event processor 128 deactivates the keyboard input processor and instantiates and/or activates a speech input processor, as indicated by box 622. Input that is then received through the microphone is processed by the speech input processor in communication with the currently active edit buffer. For example, if the user presses the dictate button 614 while the “body” edit control 608 has focus, then subsequent user input received through the microphone will be processed by the speech input processor in conjunction with the edit buffer associated with the “body” edit control 608.

In an example implementation, the input processor to be activated may be determined based on a means by which the edit control is selected. For example, as described above, if an edit control is selected via mouse click or a tab key press, then the keyboard input processor is activated. Alternatively, for example, if an edit control is selected via a voice command, rather than activating the keyboard input processor, a speech input processor may be activated.

Example Methods

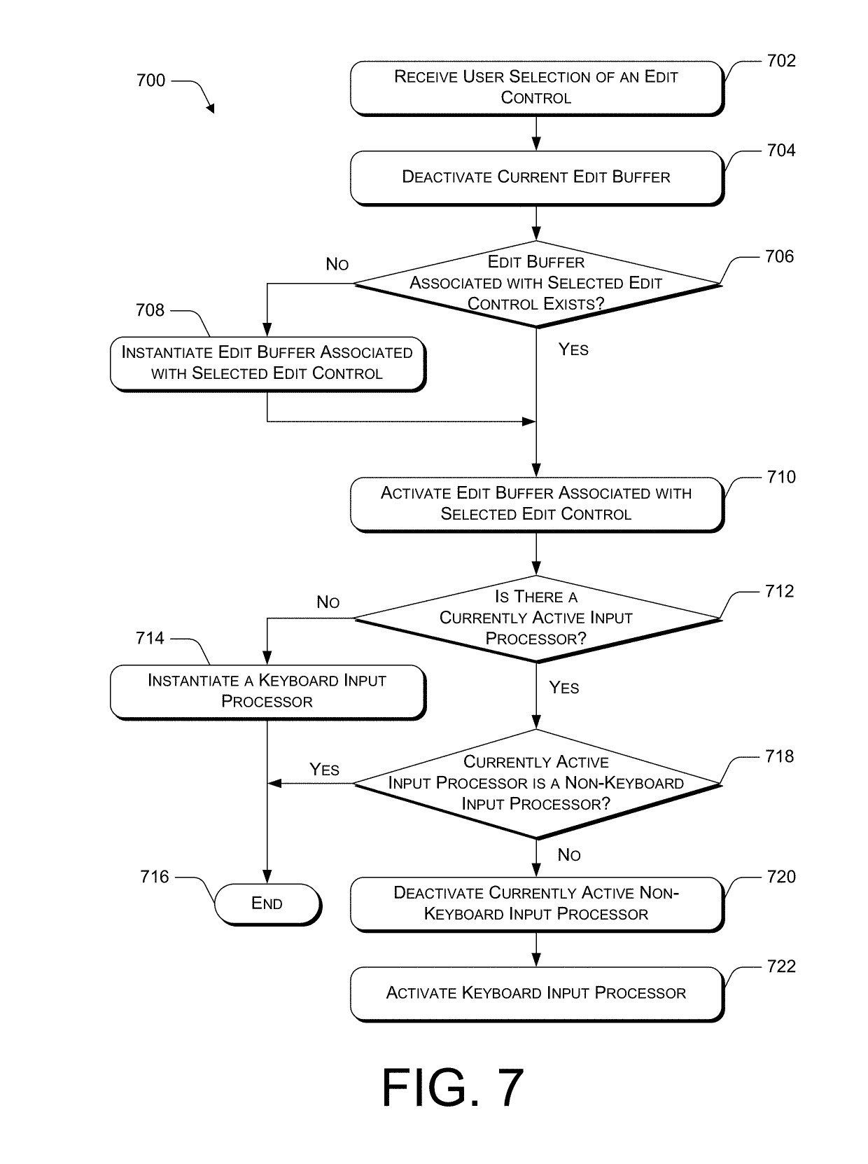

FIGS. 7-10 illustrate example processes performed by an input service as described herein. The example processes are illustrated as a collection of blocks in a logical flow graph, which represent a sequence of operations that can be implemented in hardware, software, or a combination thereof. The blocks are referenced by numbers. In the context of software, the blocks represent computer-executable instructions stored on one or more computer-readable media that, when executed by one or more processors (such as hardware microprocessors), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

FIG. 7 is a flow diagram of an example method performed when a user selects an edit control.

At block 702, user selection of an edit control is received. For example, as described above with reference to FIG. 6, an edit control may be selected when a user launches a new application or when a user clicks on or otherwise selects an edit control within a user interface associated with a running application. Key event processor 128 receives notification, from the application, of the selected edit control.

At block 704, the current edit buffer is deactivated. For example, if another edit control was previously selected, the key event processor 128 deactivates the edit buffer object 130 associated with the previously selected edit control. As a result, the edit buffer object that was previously active will move from the active state 306 to the deactive state 308.

At block 706, it is determined whether or not an edit buffer associated with the selected edit control exists. For example, key event processor 128 examines the edit buffer object in the instantiated objects 204 to determine whether an edit buffer associated with the selected edit control exits.

If no edit buffer object exists in association with the selected edit control (the “No” branch from block 706), then at block 708, key event processor 128 instantiates an edit buffer object to be associated with the selected edit control. At block 710, key event processor 128 activates the newly instantiated edit buffer object. As a result, as described above with reference to FIG. 3, the newly instantiated edit buffer object will be in the active state 306.

On the other hand, if an edit buffer object associated with the selected edit control is already instantiated (the “Yes” branch from block 706), then at block 710, key event processor 128 activates the edit buffer associated with the selected edit control, moving the edit buffer object from the deactive state 308 to the active state 306.

At block 712, it is determined whether or not there is currently an active input processor. For example, key event processor 128 examines instantiated objects 204 to determine whether there is an active keyboard input processor or an active non-keyboard input processor.

If it is determined that there is no currently active input processor (the “No” branch from block 712), then at block 714, key event processor 128 instantiates a keyboard input processor, for example, based on the current user input language.

At block 716 processing based on the received selection of an edit control ends.

On the other hand, if at block 712 it is determined that there is a currently active input processor (the “Yes” branch from block 712), then at block 718, it is determined whether or not the currently active input processor is a keyboard input processor. For example, as described above, only one input processor can be active at a given time. The active input processor will be either a keyboard input processor or a non-keyboard input processor.

If the currently active input processor is a keyboard input processor (the “Yes” branch from block 718), then processing ends at block 716 as described above.

However, if the currently active input processor is a non-keyboard input processor (the “No” branch from block 718), then at block 720, key event processor 128 deactivates the currently active non-keyboard input processor.

At block 722, the key event processor activates the currently deactive keyboard input processor.

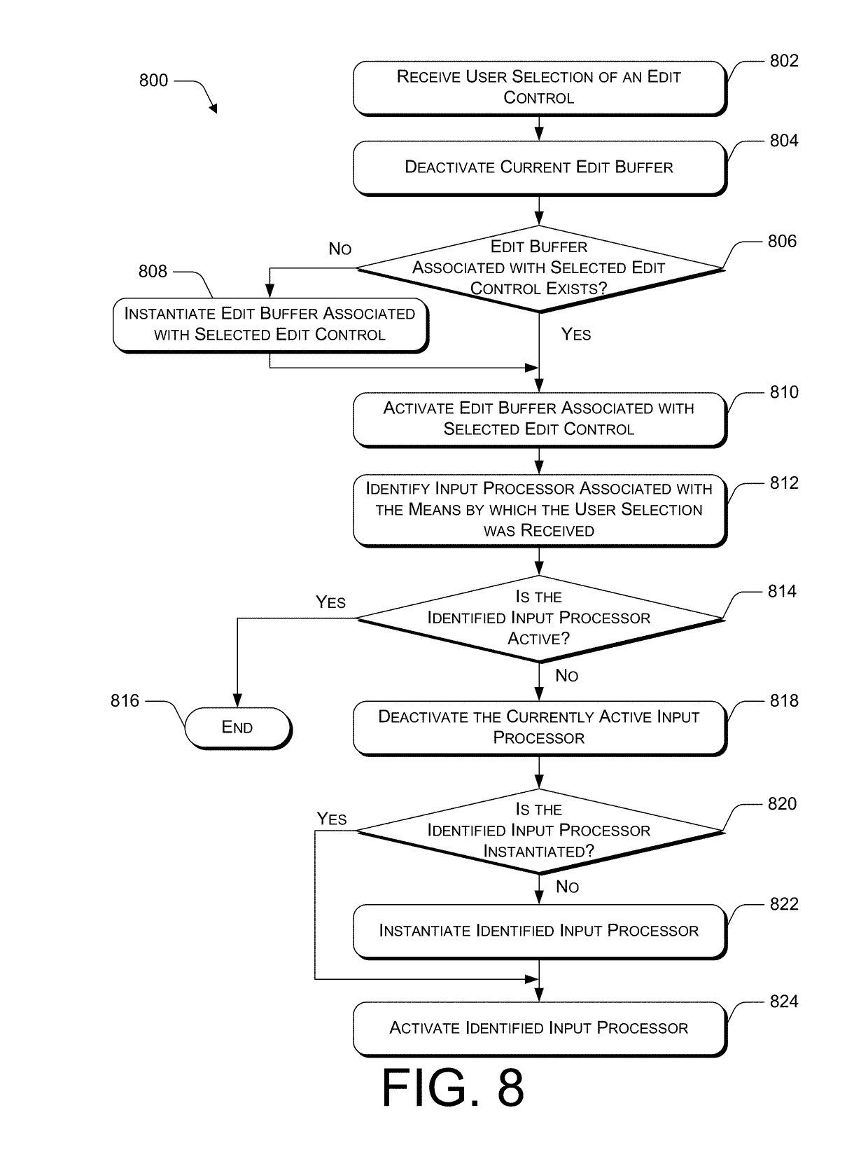

FIG. 8 is a flow diagram of an example method that may be performed when a user selects an edit control

At block 802, user selection of an edit control is received. For example, as described above with reference to FIG. 6, an edit control may be selected when a user launches a new application or when a user clicks on or otherwise selects an edit control within a user interface associated with a running application. User selection of an edit control may be made, for example, via a mouse click, a tab key press, a gesture, a touch screen interaction, a voice command, or any other input means. Key event processor 128 receives notification, from the application, of the selected edit control and the means by which the edit control was selected.

At block 804, the current edit buffer is deactivated. For example, if another edit control was previously selected, the key event processor 128 deactivates the edit buffer object 130 associated with the previously selected edit control. As a result, the edit buffer object that was previously active will move from the active state 306 to the deactive state 308.

At block 806, it is determined whether or not an edit buffer associated with the selected edit control exists. For example, key event processor 128 examines the edit buffer object in the instantiated objects 204 to determine whether an edit buffer associated with the selected edit control exits.

If no edit buffer object exists in association with the selected edit control (the “No” branch from block 806), then at block 808, key event processor 128 instantiates an edit buffer object to be associated with the selected edit control. At block 810, key event processor 128 activates the newly instantiated edit buffer object. As a result, as described above with reference to FIG. 3, the newly instantiated edit buffer object will be in the active state 306.

On the other hand, if an edit buffer object associated with the selected edit control is already instantiated (the “Yes” branch from block 806), then at block 810, key event processor 128 activates the edit buffer associated with the selected edit control, moving the edit buffer object from the deactive state 308 to the active state 306.

At block 812, an input processor is identified based on the means by which the user selection was received. For example, if the user selection of the edit control was made via a mouse click or a tab key press, the keyboard input processor may be identified. However, if the user selection was made via a voice command, a speech input processor may be identified. Other non-keyboard input processors may be associated with other means of user input.

At block 814, it is determined whether or not the input processor identified at block 812 is currently active. For example, key event processor 128 examines instantiated objects 204 to determine whether the currently active input processor is the identified input processor.

If it is determined that the currently active input processor is the input processor identified at block (the “Yes” branch from block 814), then at block 816, the process ends.

On the other hand, if it is determined that the currently active input processor is not the identified input processor (the “No” branch from block 814), then at block 818, the currently active input processor is deactivated. For example, key event processor 128 deactivates the currently active input processor.

At block 820, it is determined whether the identified input processor is instantiated. For example, key event processor 128 examines instantiated objects 204 to determine whether an object associated with the identified input processor has been instantiated.

If the identified input processor is instantiated (the “Yes” branch from block 820), then processing continues as described below with reference to block 824.

On the other hand, if the identified input processor has not been instantiated (the “No” branch from block 820), then at block 822, key event processor 128 instantiates the identified input processor.

At block 824 key event processor 128 activates the identified input processor.

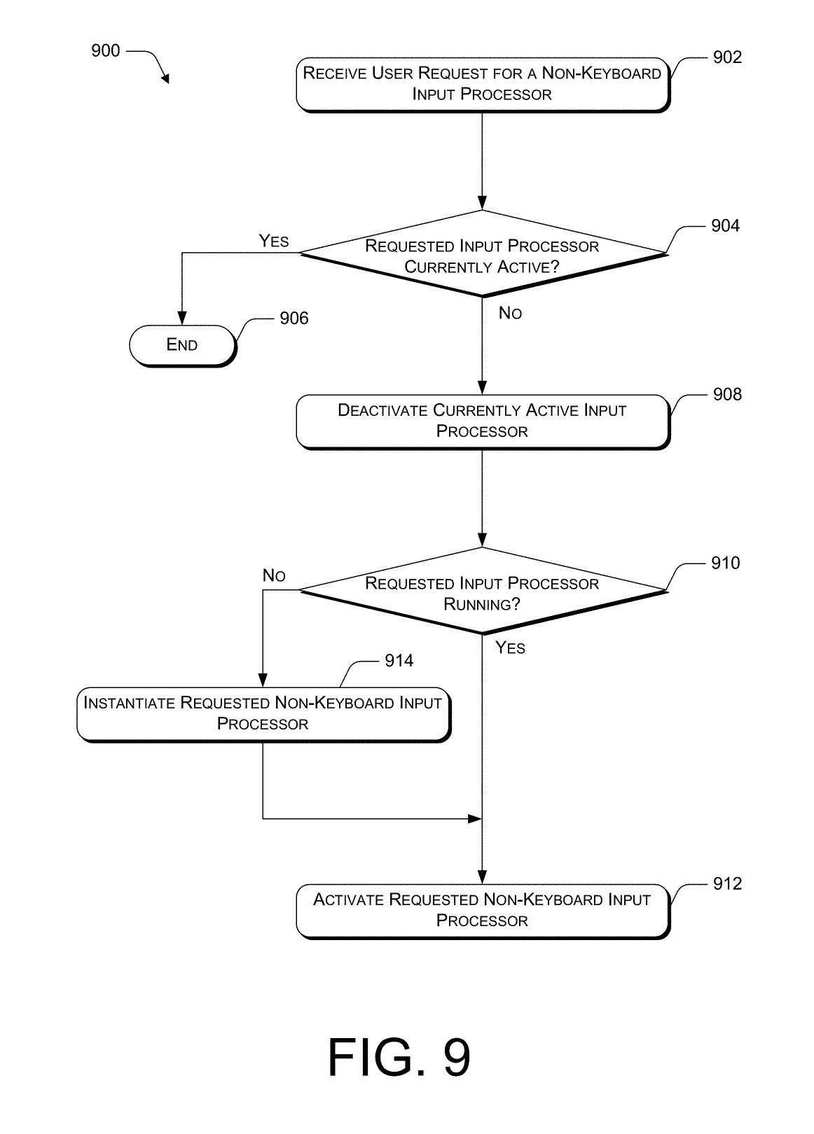

FIG. 9 is a flow diagram of an example method performed when a user requests a non-keyboard input processor.

At block 902, the input service receives a request for a non-keyboard input processor. For example, a user may select a menu item, click a button, or otherwise indicate that user input will be provided through a means other than the keyboard. For example, as described with reference to FIG. 6, a user may select a dictate button to indicate speech input through a microphone. Key event processor 128 receives the request for the non-keyboard input processor.

At block 904, it is determined whether or not the requested input processor is currently active. For example, key event processor 128 examines the instantiated objects 204 to determine whether or not the currently active input processor is the requested input processor.

If the currently active input processor is the requested input processor (the “Yes” branch from block 904), then at block 906, the process ends.

On the other hand, if the currently active input processor is not the requested input processor (the “No” branch from block 904), then at block 908, the currently active input processor is deactivated. For example, key event processor 128 instructs the currently active input processor to move from an active state 406 or 506 to a deactive state 408 or 508.

At block 910, it is determined whether or not the requested non-keyboard input processor is running (e.g., instantiated and deactive). For example, key event processor 128 examines the instantiated objects 204 to determine whether an object corresponding to the requested non-keyboard input processor exists.

If the requested non-keyboard input processor is instantiated and deactive (the “Yes” branch from block 910), then at block 912, the key event processor activates the requested non-keyboard input processor.

On the other hand, if the requested non-keyboard input processor is not yet instantiated (the “No” branch from block 910), then at block 914, the key event processor 128 instantiates the requested non-keyboard input processor. Then, at block 912, the key event processor activates the newly instantiated non-keyboard input processor.

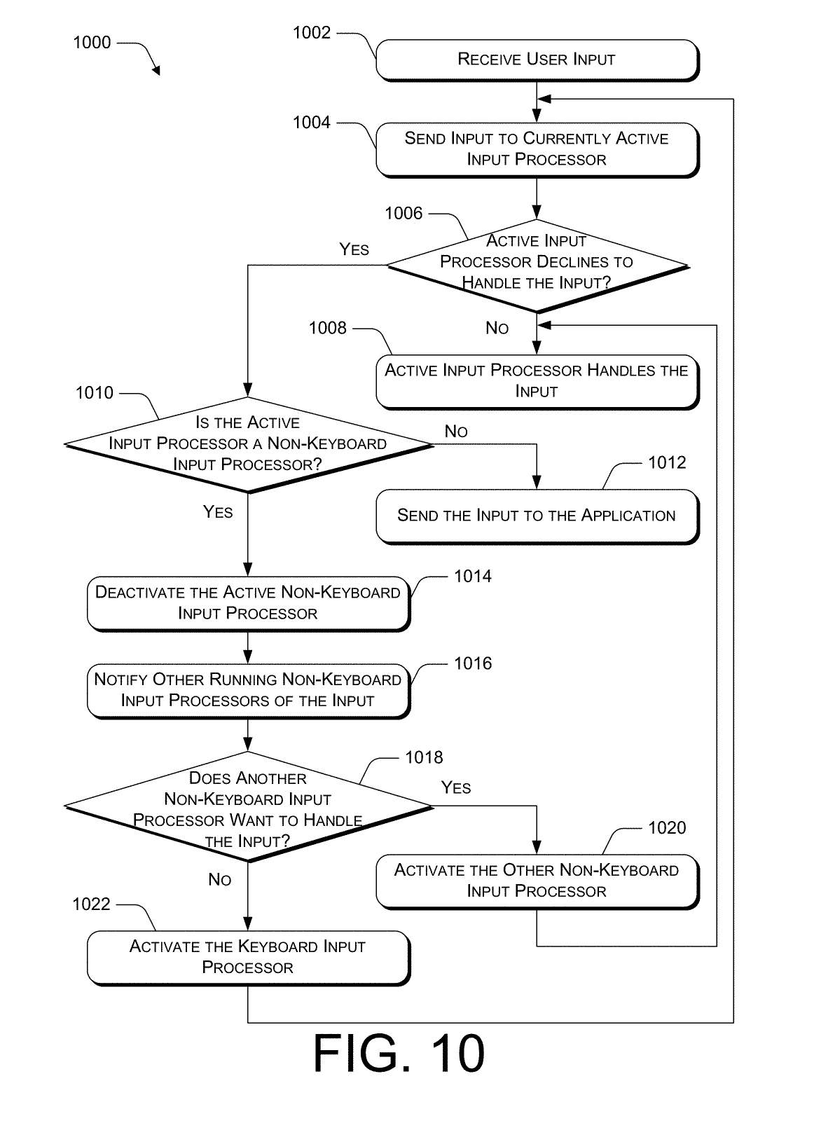

FIG. 10 is a flow diagram of an example method performed when a user input is received.

At block 1002, the input service receives user-submitted input. For example, key event processor 128 receives user input, which may be received through a keyboard, a microphone, a touch screen, or any other means of input.

At block 1004, the input is sent to the currently active input processor. For example, key event processor 128 send the received user input to the active input processor, which may be a keyboard input processor or a non-keyboard input processor.

At block 1006, it is determined whether or not the currently active input processor has declined to handle the received input. For example, if the currently active input processor is a speech input processor, and the received input is an “A” pressed on a keyboard, the speech input processor may decline to process the input.

If it is determined that the currently active input processor has not declined to handle the received input (the “No” branch from block 1006), then at block 1008, the currently active input processor processes the received user input.

On the other hand, if the currently active input processor declines to handle the received user input (the “Yes” branch from block 1006), then at block 1010, it is determined whether the currently active input processor is a non-keyboard input processor. For example, the key event processor 128 examines the instantiated objects 204 to determine which instantiated input processor is currently active.

If the currently active input processor is a keyboard input processor (the “No” branch from block 1010), then at block 1012, the received user input is sent to the application for processing. For example, because the keyboard input processor has declined to handle the user input, the key event processor 128 forwards the received user input to the application that currently has focus, to allow the application to handle the user input that was received.

On the other hand, if the currently active input processor is a non-keyboard input processor (the “Yes” branch from block 1010), then at block 1014, the active non-keyboard input processor is deactivated. For example, key event processor 128 instructs the currently active non-keyboard input processor object to move from an active state 506 to a deactive state 508.

At block 1016, other running non-keyboard input processors are notified of the input. For example, key event processor 128 sends a notification of the received user input to all of the deactive non-keyboard input processor objects, giving each an opportunity to choose to handle the received user input.

At block 1018, it is determined whether or not any of the deactive non-keyboard input processors want to handle the received user input. For example, if the input represents a command that a particular one of the non-keyboard input processors recognizes, the non-keyboard input processor may request to handle the input.

If a deactive non-keyboard input processor indicates that it would like to handle the received input (the “Yes” branch from block 1018), then at block 1020, the non-keyboard input processor is activated. For example, in response to receiving an indication from a particular non-keyboard input processor that the non-keyboard input processor can handle the received user input, the key event processor 128 activates the particular non-keyboard input processor. Processing then continues as described above with reference to block 1008.

On the other hand, if none of the deactive non-keyboard input processors request to handle the received input (the “No” branch from block 1018), then at block 1022, the keyboard input processor is activated. For example, key event processor 128 activates the currently instantiated and deactive keyboard input processor. Processing then continues as described above with reference to block 1004.

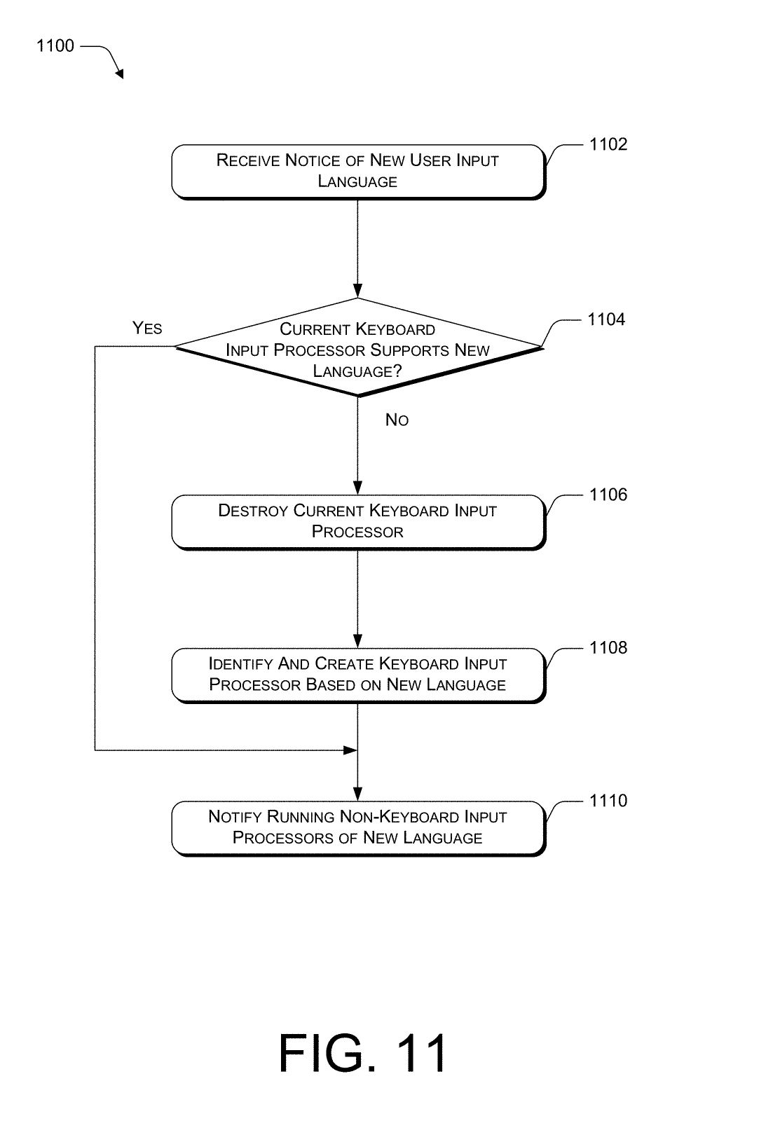

FIG. 11 is a flow diagram of an example method performed when a user's input language is changed. As described above, if multiple keyboard input processors are supported (e.g., available objects 202 includes multiple keyboard input processor objects), when the key event processor 128 instantiates a keyboard input processor, the one that is selected is typically based on the user input language, which may have a default value or may be user-selected.

At block 1102, the input service receives notice of a new user input language. For example, key event processor receives a notification from the operating system to that the user input language has been changed.

At block 1104, it is determined whether or not the current keyboard input processor supports the new user input language. For example, key event processor 128 notifies the current keyboard input processor of the new user input language and requests a response regarding whether or not the keyboard input processor supports the new user input language.

If the current keyboard input processor supports the new user input language (the “Yes” branch from block 1104), then processing continues as described below with reference to block 1110.

On the other hand, if the current keyboard input processor does not support the new user input language, (the “No” branch from block 1104), then at block 1106, the current keyboard input processor is destroyed. For example, key event processor 128 initiates a command to destroy the currently instantiated keyboard input processor object.

At block 1108, a keyboard input processor that supports the new user input language is created. For example, key event processor 128 examines the available objects 202 to identify a keyboard input processor that supports the new user input language. Based on the identified keyboard input processor, the key event processor 128 instantiates a new keyboard input processor object.

At block 1110, any running non-keyboard input processors are notified of the new language. The running non-keyboard input processors may include any number of deactive non-keyboard input processors and may include one active non-keyboard input processor. Key event processor 128 sends a notification to each of the instantiated non-keyboard input processors, indicating the new user input language. Based on this information, individual ones of the non-keyboard input processors may take action. The actions taken by the non-keyboard input processors is dependent on each particular non-keyboard input processor object. Actions taken may include, for example, but are not limited to, activating or deactivating a user interface control associated with the non-keyboard input processor, or loading and/or unloading particular language data files.

### CONCLUSION

Although the techniques have been described in language specific to structural features and/or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) 100, 102, 104, 106, or 108, such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

1. A system comprising:
one or more processors;
memory configured to be communicatively coupled to the one or more processors;
one or more applications stored in the memory and executable by the one or more processors; and
an operating system stored in the memory and executable by the one or more processors, the operating system comprising:
an input service that includes one or more input processors configured to process user input received in association with the one or more applications.

2. A system as recited in claim 1, wherein the one or more input processors include a keyboard input processor configured to receive user input via a keyboard.

3. A system as recited in claim 2, wherein the one or more input processors further includes at least one non-keyboard input processor configured to receive user input via a non-keyboard input device.

4. A system as recited in claim 3, wherein the at least one non-keyboard input processor includes at least one of:
a speech input processor;
a handwriting input processor;
a sign language input processor;
a lip reading input processor;
a translation input processor;
a transliteration input processor;
a Unicode input processor;
an emoticon input processor;
a mathematics input processor; or
an auxiliary device input processor.

5. A system as recited in claim 1, wherein the input service further includes a key event processor configured to manage the one or more input processors such that:
a single keyboard input processor is instantiated at any given time, the keyboard input processor being configured to receive user input via a keyboard;
any number of non-keyboard input processors are instantiated at any given time, the non-keyboard input processors being configured to receive user input via non-keyboard input devices; and
a single input processor is active at any given time.

6. A system as recited in claim 1, wherein the input service further includes one or more edit buffers accessible to the one or more input processors for processing the user input received in association with the application.

7. A system as recited in claim 6, wherein the input service further includes a key event processor configured to:
manage the one or more edit buffers such that:
any number of edit buffers are instantiated at any given time;
a single edit buffer is active at any given time; and
the single active edit buffer is associated with an edit control that currently has focus; and
manage the one or more input processors such that:
a single keyboard input processor is instantiated at any given time, the keyboard input processor being configured to receive user input via a keyboard;
any number of non-keyboard input processors are instantiated at any given time, the non-keyboard input processors being configured to receive user input via non-keyboard input devices; and
a single input processor is active at any given time.

8. A method comprising:
receiving an indication of an edit control that currently has focus, wherein the edit control is associated with an application;
activating, within an input service of the operating system, an input processor to process user input targeted at the edit control that currently has focus.

9. A method as recited in claim 8, wherein:
receiving the indication of the edit control that currently has focus includes receiving an indication of an input device through which a user selected the edit control that currently has focus; and
activating the input processor includes selecting the input processor from a plurality of input processors, wherein the selecting is based, at least in part, on the input device through which the user selected the edit control that currently has focus.

10. A method as recited in claim 8, further comprising activating, within the input service of the operating system, an edit buffer associated with the edit control that currently has focus.

11. A method as recited in claim 10, wherein activating the edit buffer includes deactivating, within the input service of the operating system, an edit buffer associated with an edit control that previously had focus.

12. A method as recited in claim 11, wherein the edit control that previously had focus is associated with another application.

13. A method as recited in claim 8, wherein activating the keyboard input processor includes instantiating a keyboard input processor object.

14. One or more computer-readable media comprising computer executable instructions that, when executed by a processor, configure a computing device to perform operations comprising:
providing to one or more applications, access to a plurality of input processors, the plurality of input processors configured to receive user input submitted via the one or more applications and to process the user input; and
managing the plurality of input processors such that at any given time:
a single keyboard input processor is instantiated;
any number of non-keyboard input processors are instantiated; and
a single input processor is active.

15. One or more computer-readable media as recited in claim 14, wherein managing the plurality of input processors comprises:
receiving a request to activate a non-keyboard input processor; and
in response to receiving the request:
deactivating a currently active input processor; and
activating the requested non-keyboard input processor.

16. One or more computer-readable media as recited in claim 15, wherein activating the requested non-keyboard input processor includes instantiating a non-keyboard input processor object.

17. One or more computer-readable media as recited in claim 14, wherein managing the plurality of input processors comprises:
receiving user input targeted at the currently selected edit control;
sending the user input to the active input processor, wherein the active input processor is a keyboard input processor; and
in an event that the active input processor declines to handle the user input, returning the user input to the application associated with the currently selected edit control.

18. One or more computer-readable media as recited in claim 14, wherein managing the plurality of input processors comprises:
receiving user input targeted at the currently selected edit control;
sending the user input to the active input processor, wherein the active input processor is a non-keyboard input processor;
in an event that the active input processor declines to handle the user input:
deactivating the active input processor;
activating the keyboard input processor; and
sending the user input to the keyboard input processor.

19. One or more computer-readable media as recited in claim 14, wherein managing the plurality of input processors comprises:
receiving user input targeted at the currently selected edit control;
sending the user input to the active input processor, wherein the active input processor is a non-keyboard input processor; and
in an event that the active input processor declines to handle the user input:
deactivating the active input processor;
notifying one or more deactive non-keyboard input processors of the user input; and
receiving, from a particular non-keyboard input processor of the one or more deactive non-keyboard input processors, a request to handle the user input:
in response to receiving the request to handle the user input:
activating the particular non-keyboard input processor; and
sending the user input to the particular non-keyboard input processor.

20. One or more computer-readable media as recited in claim 14, wherein managing the plurality of input processors comprises:
receiving a notification of a new user input language;
destroying an instantiated first keyboard input processor object, wherein the first keyboard input processor object does not support the new user input language;
instantiating a second keyboard input processor object, wherein the second keyboard input processor object supports the new user input language; and
notifying an instantiated non-keyboard input processor object of the new user input language.
